(19) United States
(12) Patent Application Publication
(10) Pub. No.: US 2019/0147620 A1
(43) Pub. Date: May 16, 2019

(54) DETERMINING OPTIMAL CONDITIONS TO PHOTOGRAPH A POINT OF INTEREST

(71) Applicant: INTERNATIONAL BUSINESS MACHINES CORPORATION, ARMONK, NY (US)

(72) Inventor: Florian Pinel, New York, NY (US)

(21) Appl. No.: 15/811,840

(22) Filed: Nov. 14, 2017

(51) Int. Cl. G06T 7/80; G06N 99/00; G06N 5/04; G06K 9/62; H04N 5/232; G06T 7/00; G06K 9/46

(52) U.S. Cl. CPC G06T 7/80; G06N 99/005; G06N 5/04; G06K 9/6215; G06T 2207/30168; G06T 7/0002; G06K 9/4647; H04N 5/23216; H04N 5/23222

(57) ABSTRACT

Embodiments of the present invention disclose a method, a computer program product, and a computer system for determining optimal conditions to photograph a point of interest. A computer first receives a point of interest and user preferences. The computer identifies images of the point of interest and extracts image parameters from the identified images. The computer evaluates a quality of the identified images and trains a model that correlates the evaluated image quality with the extracted image parameters. Lastly, the computer determines optimal conditions for capturing images of the point of interest based on the trained model.

### BACKGROUND

The present invention relates generally to digital image processing, and more particularly to determining optimal conditions to photograph a point of interest.

With advances in camera and smart phone technologies, photographs have steadily become ubiquitous in everyday life. While individuals love taking pictures of attractions, they rarely think about the optimal photographic conditions ahead of time while planning their events, trips, and itineraries. This results in countless missed opportunities and mediocre, backlit pictures. In practice, the best place to capture a photo or video of a point of interest is rarely the first place an individual looks. Moreover, as monuments, buildings, and other points of interest tend to be fixed, there are generally angles and times more favorable to capturing a high quality photo.

### SUMMARY

Embodiments of the present invention disclose a method, a computer program product, and a computer system for determining optimal conditions to photograph a point of interest. A computer first receives a point of interest and user preferences. The computer identifies images of the point of interest and extracts image parameters from the identified images. The computer evaluates a quality of the identified images and trains a model that correlates the evaluated image quality with the extracted image parameters. Lastly, the computer determines optimal conditions for capturing images of the point of interest based on the trained model.

### BRIEF DESCRIPTION OF THE SEVERAL VIEWS OF THE DRAWINGS

FIG. 1 depicts a schematic diagram illustrating the components of photo optimizing system 100, in accordance with an embodiment of the present invention.

FIG. 2 depicts a flowchart illustrating the operations of photo optimizer 152 of photo optimizing system 100 in determining optimal conditions to photograph a point of interest, in accordance with an embodiment of the present invention.

FIG. 3 is a block diagram depicting the hardware components of photo optimizing system 100 of FIG. 1, in accordance with an embodiment of the present invention.

FIG. 4 depicts a cloud computing environment, in accordance with an embodiment of the present invention.

FIG. 5 depicts abstraction model layers, in accordance with an embodiment of the present invention.

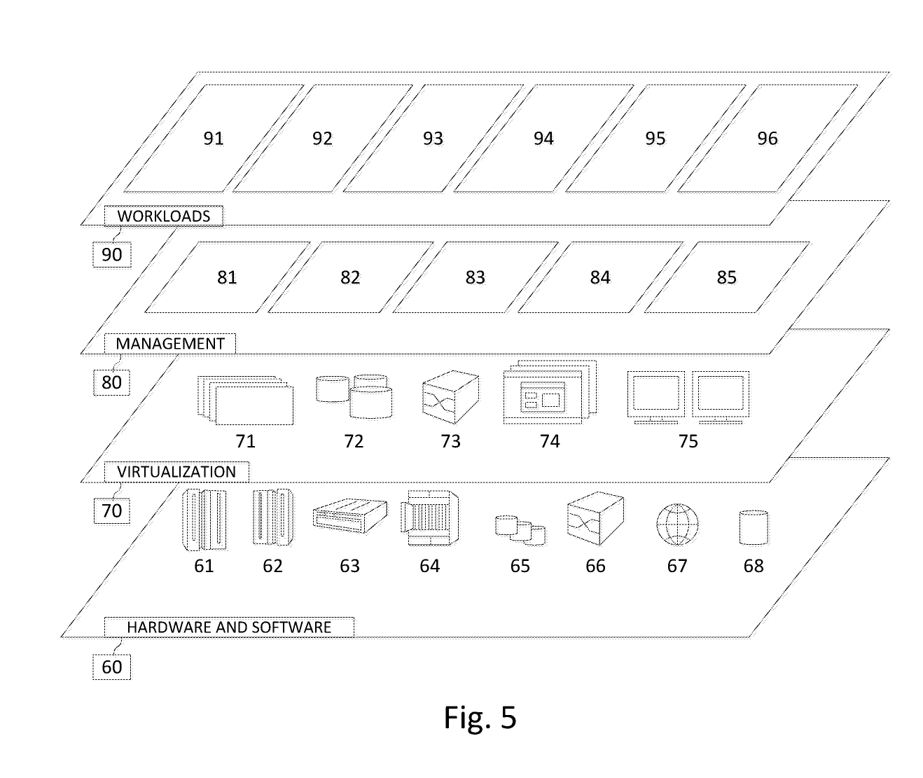

### DETAILED DESCRIPTION

The invention herein presents a solution for determining optimal conditions to photograph a point of interest. In the embodiments described herein, the term “photograph” includes capturing video and any other forms of image capture, such as selfies and panoramic images. Moreover, as used herein, “optimal conditions” may refer to a time, location, shooting angle, camera setting, light level, and other factors considered in capturing images of a point of interest. Lastly, as used herein, a “point of interest” may be natural phenomena, such as a park, mountain, beach, forest, or river, as well as manmade objects, such as a monument, building, sculpture, bridge, and any other photographed object or scene.

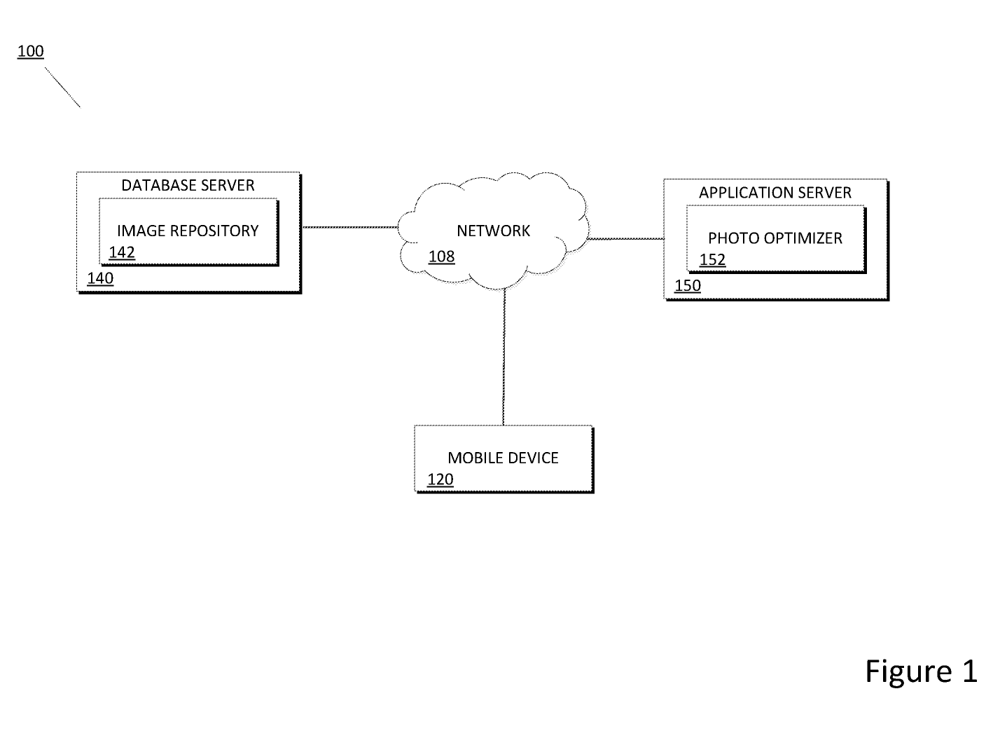

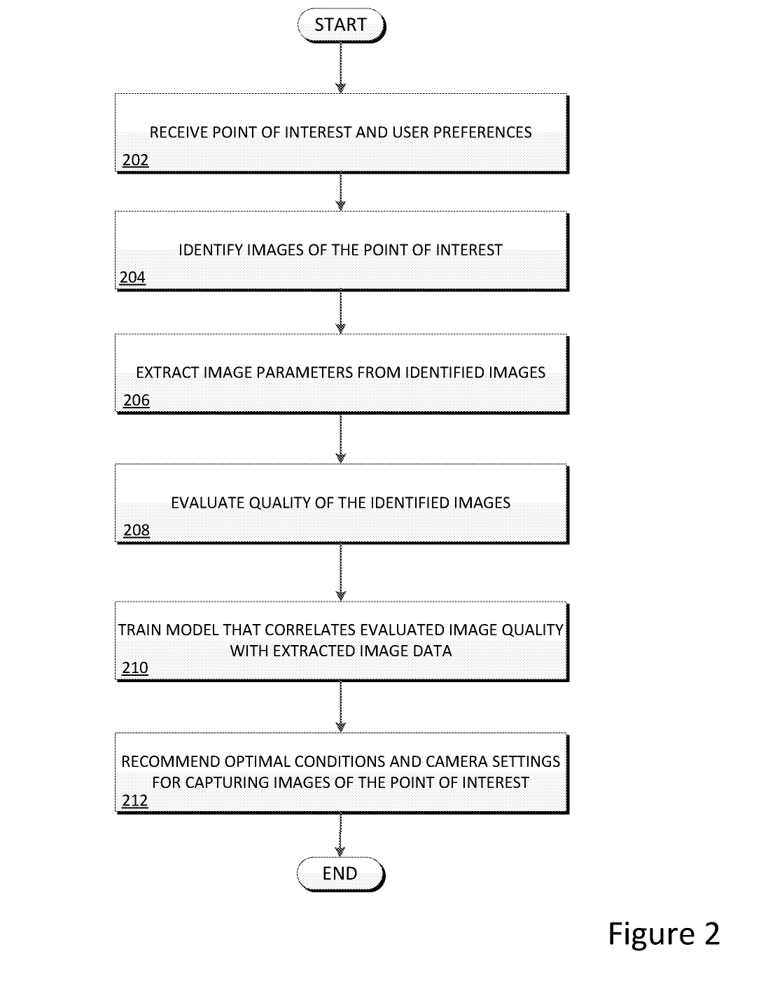

An photo optimizing system 100 in accordance with an embodiment of the invention is illustrated by FIG. 1. In the example embodiment, photo optimizer 152 analyses previous images of a point of interest to determine which image parameters resulted in a highest quality photo. Based on the image parameters resulting in the highest quality photo, photo optimizer 152 recommends optimal conditions for photographing the point of interest. The operations of photo optimizer 152 is described in more detail with reference to FIG. 2.

In the example embodiment, network 108 is a communication channel capable of transferring data between connected devices. In the example embodiment, network 108 may be the Internet, representing a worldwide collection of networks and gateways to support communications between devices connected to the Internet. Moreover, network 108 may include, for example, wired, wireless, or fiber optic connections which may be implemented as an intranet network, a local area network (LAN), a wide area network (WAN), or any combination thereof. In further embodiments, network 108 may be a Bluetooth network, a WiFi network, or a combination thereof. In yet further embodiments, network 108 may be a telecommunications network used to facilitate telephone calls between two or more parties comprising a landline network, a wireless network, a closed network, a satellite network, or any combination thereof. In general, network 108 can be any combination of connections and protocols that will support communications between mobile device 120, database server 140, and application server 150.

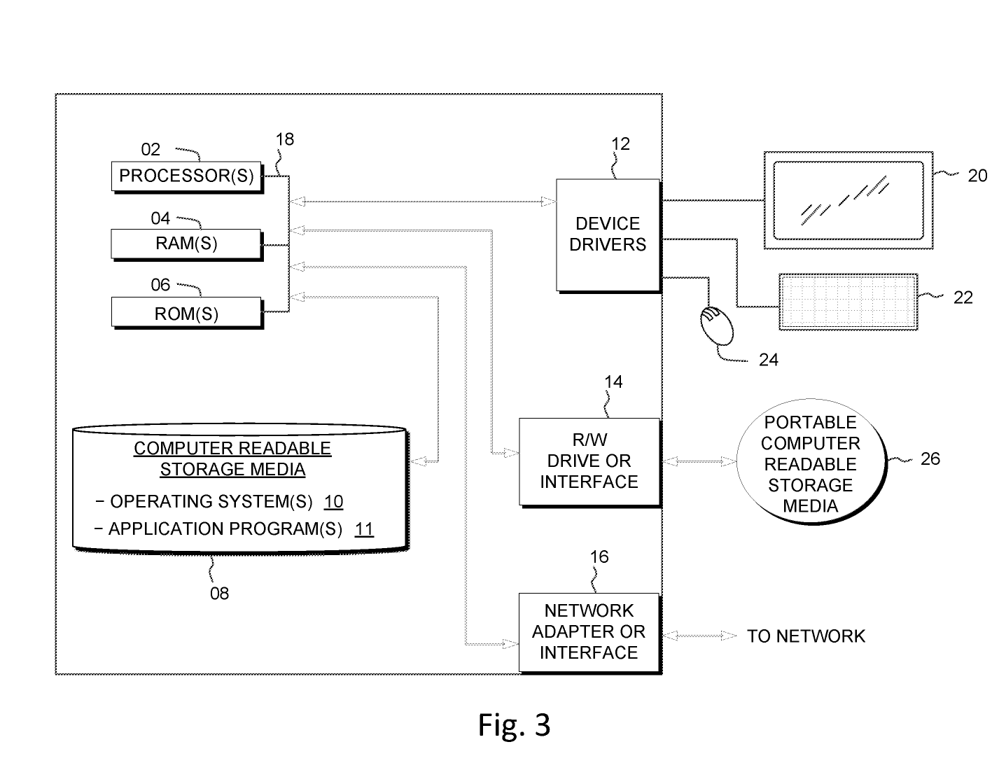

Mobile device 120 may be a laptop computer, a notebook, a tablet computer, a netbook computer, a personal computer (PC), a personal digital assistant (PDA), a smart phone, a mobile phone, a virtual device, a thin client, or any other electronic device. In the example embodiment, mobile device 120 includes an integrated camera for capturing images, such as selfies and panoramic images, as well as videos and other image capture media. Moreover, the integrated camera may have built in options such as adjustable/automatic zoom, adjustable shutter speed, aperture settings, white balance, facial recognition, filtering options, and other state of the art camera functions. Mobile device 120 further includes a global positioning system (GPS) capable of providing precise location information of mobile device 120. In addition, mobile device 120 includes a gyroscope and accelerometer capable of providing movement and orientation information of mobile device 120. Mobile device 120 is described in greater detail with reference to FIG. 3.

Database server 140 includes image repository 142 and is a computing device configured to store and provide access to large amounts of data. In the example embodiment, database server 140 may be a laptop computer, a notebook, a tablet computer, a netbook computer, a personal computer (PC), a desktop computer, a personal digital assistant (PDA), a smart phone, a mobile phone, a virtual device, a thin client, or any other electronic device or computing system capable of receiving and sending data to and from other computing devices. While in the example embodiment database server 140 is stored remotely and accessed via network 108, database server 140 may be accessed locally in other embodiments. Moreover, although database server 140 is shown as a single device, in other embodiments, database server 140 may be comprised of a cluster or plurality of computing devices, working together or working separately. Database server 140 is described in more detail with reference to FIG. 3.

Image repository 142 contains a collection of images and videos. In the example embodiment, images and videos contained in image repository 142 may be public, private, commercial, etc. and capture various scenes and people from around the world, including the images and videos of social media platforms, art galleries, travel agencies, municipal/state/federal websites, federal agencies, educational and research institutions, non-profits, and the like. In the example embodiment, image repository 142 contains images of points of interest, including natural phenomena such as parks, mountains, beaches, forests, rivers, as well as manmade objects, such as monuments, buildings, bridges, cities, etc.

Application server 150 includes photo optimizer 152 and may be a laptop computer, a notebook, a tablet computer, a netbook computer, a personal computer (PC), a desktop computer, a personal digital assistant (PDA), a smart phone, a mobile phone, a virtual device, a thin client, or any other electronic device or computing system capable of receiving and sending data to and from other computing devices. While application server 150 is stored remotely and accessed via network 108 in the example embodiment, application server 150 may be accessed locally in other embodiments. Moreover, although application server 150 is shown as a single device, in other embodiments, application server 150 may be comprised of a cluster or plurality of computing devices, working together or working separately. Application server 150 is described in more detail with reference to FIG. 3.

In the example embodiment, photo optimizer 152 is a computer application that is capable of receiving a point of interest and user preferences. Photo optimizer 152 is further capable of identifying images of the point of interest and extracting image parameters from the identified images. In addition, photo optimizer 152 is capable of evaluating a quality of the identified images and training a model that correlates the evaluated image quality with the extracted image parameters. Photo optimizer 152 is further capable of recommending optimal conditions for photographing the point of interest based on the trained model. The operations of photo optimizer 152 are described in greater detail with respect to FIG. 2.

FIG. 2 depicts a diagram illustrating the operations of photo optimizer 152 in determining optimal conditions to photograph a point of interest, in accordance with an embodiment of the present invention.

Photo optimizer 152 receives a point of interest and user preferences (step 202). In the example embodiment, a point of interest corresponds to a tangible or intangible attraction, scene, view, etc., and may include natural phenomena such as natural parks, mountains, beaches, forests, rivers, and the like. In addition, the point of interest may correspond to manmade objects, such as monuments, buildings, sculptures, bridges, or a combination of both natural and manmade scenery. Overall, the point of interest may correspond to any object or scene that is the subject of at least one image. In the example embodiment, photo optimizer 152 may receive a point of interest and user preferences individually or in bulk as user input via mobile device 120 or other computing devices via network 108. In the example embodiment, photo optimizer 152 may additionally receive user preferences as they relate to photographing the point of interest. Such user preferences may include a type of media to capture (e.g. image, selfie, panoramic, video, GIF, etc.), a preferred filter, whether the image will include people, a capturing height/angle, time of year, preferred features, an availability time-frame, a deviation threshold from the point of interest, what the image will be used for, etc. In addition, the user preferences may further include mobile device 120 camera specifications such that photo optimizer 152 can recommend specific settings based on the camera type and capabilities. Such camera specifications may include a manufacturer, model, shutter speed, aperture, white balance, ISO, lens, filter, resolution, aspect ratio, and the like.

With reference now to an illustrative example, photo optimizer 152 receives a monument as a point of interest from a tourist as well as user preferences, including a type of camera owned by the tourist and the preference to take a selfie.

Photo optimizer 152 identifies images depicting the point of interest (step 204). In the example embodiment, photo optimizer 152 identifies images depicting the point of interest from candidate images contained in image repository 142. Such images may include those posted on social media, travel websites, municipal/state/federal websites, government agencies, historical societies, professional photography websites, and the like. In addition, photo optimizer 152 identifies images depicting the point of interest from images taken/stored on mobile device 120 and images taken by other users of photo optimizer 152, for example other users photographing points of interest. In another embodiment, images are obtained from various networks of outdoor cameras, such as surveillance cameras or cameras used on digital billboards. In the example embodiment, photo optimizer 152 identifies images depicting the point of interest using data and image analysis techniques. One such technique involves applying image recognition to the candidate images in order to find features indicative of the received point of interest. In such embodiments, photo optimizer 152 utilizes pattern and template recognition techniques to compare one or more verified images, such as those verified by human or computer, of the point of interest with the one or more candidate images to identify those having similar features. In order to better identify the point of interest in candidate images captured at angles not depicted by the verified images, photo optimizer 152 may be further configured to apply techniques such as structure from motion to visualize other sides of the point of interest. Then, if the candidate images capture a side of the point of interest not depicted by the verified images, photo optimizer 152 may still be able to determine that a candidate image is in fact capturing the point of interest. In the example embodiment, photo optimizer 152 is further configured to apply other image analysis techniques to the candidate images. For example, photo optimizer 152 applies optical character recognition (OCR) to identify written language within the candidate images that may be indicative of the point of interest, such as a building address, plaque, or street sign. Photo optimizer 152 may apply other techniques in identifying candidate images depicting the point of interest, such as template matching, anisotropic diffusion, Hidden Markov models, independent component analysis, linear filtering, neural networks, partial differential equations, pixilation, and the like.

Referencing the earlier-introduced example regarding the monument, photo optimizer 152 applies image recognition techniques to compare verified images of the monument, for example those on a historic website, to candidate images within image repository 142. Photo optimizer 152 may further compare images taken of the monument by other users of photo optimizer 152 in the past to the candidate images. Photo optimizer 152 may further apply structure from motion techniques to determine what other sides of the monument look like not depicted by the verified or previously taken photos and compare the structure from motion results to the candidate images. Based on the comparison, photo optimizer 152 identifies one or more candidate images having a similar shading, pattern, pixel mapping, and/or contrast to the verified images and identifies them as capturing the monument.

Photo optimizer 152 further identifies images of the point of interest by applying data analysis techniques to data associated with the one or more candidate images (step 204 continued). In the example embodiment, photo optimizer 152 analyses metadata and exchangeable image files (EXIF) associated with the candidate images for information indicative of the point of interest, for example a geotag that matches a geotag of the point of interest. In addition, photo optimizer 152 may also identify images having geotags corresponding to locations that have a view of the point of interest suitable for photographing. For example, the skyscraper can be photographed from many different geotags, including from the ground, other skyscrapers, etc., while a particular statue may only be visible and thus photographed from one geotag. In some embodiments, photo optimizer 152 may be configured to identify geotags from which the point of interest may be photographed from by, when first receiving a point of interest, considering all images determined to be of the point of interest through image analysis regardless of geotag. Then, based on the quality of the images (determination thereof described in the proceeding paragraphs), photo optimizer 152 determines which geotags are appropriate for a particular point of interest by, for example, requiring the determined quality exceed a threshold. In some embodiments, photo optimizer 152 may use other techniques for identifying images of the point of interest, including using the measurements from the gyroscope and camera autofocus from mobile device 120 in combination with the geotag. Furthermore, photo optimizer 152 may reference information regarding a Bluetooth or Wifi network used to upload a candidate image to the cloud and utilize natural language processing and other data processing methods to determine whether the network corresponds to a particular point of interest. In yet further embodiments, photo optimizer 152 may identify images of the point of interest by analysing captions, tags, or titles associated with images posted online, for example on social media and travel websites. Lastly, photo optimizer 152 further identifies images depicting the point of interest when the program itself is being used for optimal condition recommendations. When a user photographs a point of interest, photo optimizer 152 stores the image in association with the received point of interest which can later be cross-referenced for future photographing of the point of interest.

Continuing the previously-introduced example, photo optimizer 152 analyses metadata and EXIF data associated with the candidate images to identify geotags corresponding to the monument, hashtags/tags of the monument, coordinates associated with cardinal directions facing the monument, and image descriptions mentioning the monument. In some embodiments where photo optimizer 152 is not yet sure which geotags to associate with the monument, photo optimizer 152 may first rely on image analysis to identify images of the monument regardless of geotag and then, in the subsequently discussed quality analysis, narrow acceptable geotags for the monument to only those having images exceeding a threshold quality. This geotag determination may be updated as necessary by photo optimizer 152, for example, when a threshold amount of images within previously-determined unacceptable geotags are identified. When this threshold is hit, photo optimizer 152 may reconsider such geotags and, if the quality of images resulting from such geotags exceeds the threshold quality, add such geotags to the acceptable geotags for the particular point of interest. This feature may be further useful as camera technologies advance and images can be taken from further away, from different angles, etc. as well as to adjust to changing points of interest.

Photo optimizer 152 extracts image parameters from the images identified as depicting the point of interest (step 206). In the example embodiment, photo optimizer 152 utilizes both data and image analysis techniques to extract parameters from the identified images as they relate to how and when the identified image was photographed. To this point, photo optimizer 152 analyses corresponding metadata or EXIF data to extract parameters such as a time of day, time of year, location (geotag, GPS coordinates, etc.), altitude, a direction the photographer was facing (cardinal direction), the position of the sun, a light level, camera settings, and the like. In cases where the identified images lack robust metadata, photo optimizer 152 may be further configured to determine parameters based on further analysis. For example, photo optimizer 152 analyses user profiles corresponding to the photographer (i.e. social media indicates the photographer is six feet tall) and the identified images themselves to determine an angle/height at which the image was taken, an angle of incidence, an angle of refraction, etc. For example, photo optimizer 152 may identify shadows, shading gradients, and reflections to identify the direction of the sun and determine a direction the mobile device 120 is facing when capturing the image. Similarly, photo optimizer 152 may utilize OCR to identify stores or businesses in the background of an image and, by cross-referencing the names of the identified businesses with online resources such as maps, determine which direction mobile device 120 is facing when capturing the image. Moreover, photo optimizer 152 may further analyse light levels and weather patterns, for example cross-referencing weather conditions captured by the image (e.g. snow) with public records of weather conditions at the point of interest, to determine when and where the candidate image was taken. Similarly, photo optimizer 152 may reference satellite/street-level imagery to identify objects in the background of the images, including both permanent objects (buildings, streets, etc.) as well as temporary objects (billboards, construction, etc.), and may further apply structure from motion techniques to the imagery to reconcile differences in capture angles. In general, photo optimizer 152 may apply any known techniques to the identified images in order to extract image parameters relevant to the manner in which the identified images were captured.

With reference to the example introduced above, photo optimizer 152 analyses metadata associated with the identified images to determine that one of the identified images was taken from ground level facing west at 6:00 PM on October 10^{th}. Similarly, photo optimizer 152 determines that another one of the identified images was taken at an elevation commensurate with the second-floor terrace of a nearby restaurant to the east of the monument at roughly 3:00 PM on March 1st, as determined by a distance to objects on the ground, a barometric pressure, and a reflection of the sun. Lastly, photo optimizer 152 applies OCR to a building address captured in the background of an identified image of the monument in conjunction with directional analysis to determine that the image was taken from the north at 11:00 AM on December 15th.

Photo optimizer 152 evaluates a quality of the identified images (step 208). In the example embodiment, photo optimizer 152 determines a quality of the identified images using image histograms. Image histograms are a type of histogram that acts as a graphical representation of the tonal distribution in a digital image. More specifically, an image histogram plots the number of pixels for each tonal value comprising the image. The horizontal axis of the histogram represents the tonal variations, while the vertical axis represents the number of pixels in that particular tone. From left to right, the tones on the horizontal axis go from the black and dark areas to the medium grey areas and finally to light and pure white areas. The vertical axis represents the size of the area that is captured in each one of these zones. Thus, the histogram for a very dark image will have the majority of its data points on the left side and center of the graph. Conversely, the histogram for a very bright image with few dark areas and will have most of its data points on the right side and center of the graph. In addition to the an amount of pixels corresponding to each tone of the image, the histogram can be further used to determine blown-out highlights, blacked-out shadows, brightness, contrast, and whether the image was backlit. Photo optimizer 152 may further base image quality on other factors as well, either by default or user preferences, including image saliency, image frequency, user ratings (e.g. likes, shares), source (social media, online magazine, travel website, professional photography website, etc.), awards, presence of a copyright, and various image quality metrics calculated by machine learning algorithms.

Continuing the earlier-introduced example, photo optimizer 152 creates an image histogram for each of the images identified as capturing the monument and evaluates a quality of the images based on the histograms, user reviews, and the sources of the images.

Photo optimizer 152 trains a model that correlates image quality with the extracted image parameters (step 210). In the example embodiment, photo optimizer 152 trains the model through application of a machine learning (ML) algorithm to a set of training data, i.e. the images identified as photographing the point of interest above, to identify a target, i.e. image quality. The ML algorithm finds patterns in the training data that map the input data attributes, i.e. image parameters, to the target and outputs an ML model that captures these patterns. From these patterns, the most prominent image parameters can be extracted and leveraged for suggesting best conditions for capturing the point of interest that is improved as more training data is ingested. In other embodiments, photo optimizer 152 may apply other techniques to correlate image quality with image parameters, including ML algorithms such as decision trees, regression, support vector machines, neural networks, etc. In yet further embodiments, photo optimizer 152 may also apply unsupervised ML algorithms to cluster the images of the point of interest, let users choose a cluster they like best, and calculate typical parameter values for the images in that cluster.

With reference again to the example above, photo optimizer 152 trains a machine learning model to target image quality based on the evaluated image quality and extracted image parameters of the images identified as depicting the point of interest.

Photo optimizer 152 recommends optimal conditions and camera settings for photographing the point of interest (step 212). Based on the patterns and prominent image parameters identified by the trained ML model, photo optimizer 152 determines which combinations of conditions produce the highest quality images, as determined above. In the example embodiment, the optimal conditions include conditions relevant to capturing images of the point of interest, including angle, height, time, day, location, and the like. Moreover, the optimal conditions may be grouped into hard and soft requirements based, in part, on the user preferences received earlier. In the example embodiment, hard requirements are those that cannot be changed while soft requirements are those that may be flexible. For example, the tourist in the example above may only be in the location of the monument for a single day or hour and, thus, even if the optimal conditions recommend photographing the monument on a different day/time having better weather, the day condition is a hard requirement that must be met. Accordingly, photo optimizer 152 determines optimal conditions for photographing the monument on that particular day, regardless of identifying more optimal conditions on different days. Conversely, soft requirements are those which are flexible to some degree and, in some embodiments, may include some preparation. In the example above, for instance, a best location for photographing the monument may require a short walk of ten minutes to the second-floor restaurant terrace while a photograph from the current location results in an image having only slightly less quality. Here, the location condition is soft because although the image may be of higher quality from the second-floor terrace, it is not required the tourist photograph the monument from that location for a reasonable quality image. Moreover, moving to the new location requires some preparation, i.e. time to get there, which may not be practical for the tourist and thus the condition is soft. In the example embodiment, photo optimizer 152 is configured to strictly adhere to hard requirements and provide several different options for soft requirements. In the example above, photo optimizer 152 provides predicted qualities for photographing the monument from the current location of the tourist and the second-floor terrace on the particular day the tourist is in town. Such recommendations can be broken down by common statistics, such as a percentage of images taken of the point of interest having these conditions exceed a particular quality, while only a small percentage of images taken of the point of interest having these conditions exceed the particular quality.

In addition, photo optimizer 152 further recommends camera settings for photographing the point of interest (step 212 continued). Such camera settings may include a shutter speed, aperture, ISO, zoom, etc. Like the recommended optimal conditions, recommended camera settings are based on the camera settings of images evaluated to have a highest quality under similar conditions. In the example above, for example, photo optimizer 152 may recommend to the tourist no zoom and a long exposure when taking a selfie with the monument. Because the model is trained with regard to date and time, photo optimizer 152 is capable of providing recommended settings for future dates as well. For example, photo optimizer 152 may receive photographing recommendations in real time or for future time frames.

FIG. 3 depicts a block diagram of the computing devices utilized by photo optimizing system 100 of FIG. 1, in accordance with an embodiment of the present invention. It should be appreciated that FIG. 3 provides only an illustration of one implementation and does not imply any limitations with regard to the environments in which different embodiments may be implemented. Many modifications to the depicted environment may be made.

Mobile device 120 may include one or more processors 02, one or more computer-readable RAMs 04, one or more computer-readable ROMs 06, one or more computer readable storage media 08, device drivers 12, read/write drive or interface 14, network adapter or interface 16, all interconnected over a communications fabric 18. Communications fabric 18 may be implemented with any architecture designed for passing data and/or control information between processors (such as microprocessors, communications and network processors, etc.), system memory, peripheral devices, and any other hardware components within a system.

One or more operating systems 10, and one or more application programs 11, for example photo optimizer 152, are stored on one or more of the computer readable storage media 08 for execution by one or more of the processors 02 via one or more of the respective RAMs 04 (which typically include cache memory). In the illustrated embodiment, each of the computer readable storage media 08 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Mobile device 120 may also include a R/W drive or interface 14 to read from and write to one or more portable computer readable storage media 26. Application programs 11 on said devices may be stored on one or more of the portable computer readable storage media 26, read via the respective R/W drive or interface 14 and loaded into the respective computer readable storage media 08.

Mobile device 120 may also include a network adapter or interface 16, such as a TCP/IP adapter card or wireless communication adapter (such as a 4G wireless communication adapter using OFDMA technology). Application programs 11 on said computing devices may be downloaded to the computing device from an external computer or external storage device via a network (for example, the Internet, a local area network or other wide area network or wireless network) and network adapter or interface 16. From the network adapter or interface 16, the programs may be loaded onto computer readable storage media 08. The network may comprise copper wires, optical fibers, wireless transmission, routers, firewalls, switches, gateway computers and/or edge servers.

Mobile device 120 may also include a display screen 20, a keyboard or keypad 22, and a computer mouse or touchpad 24. Device drivers 12 interface to display screen 20 for imaging, to keyboard or keypad 22, to computer mouse or touchpad 24, and/or to display screen 20 for pressure sensing of alphanumeric character entry and user selections. The device drivers 12, R/W drive or interface 14 and network adapter or interface 16 may comprise hardware and software (stored on computer readable storage media 08 and/or ROM 06).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Based on the foregoing, a computer system, method, and computer program product have been disclosed. However, numerous modifications and substitutions can be made without deviating from the scope of the present invention. Therefore, the present invention has been disclosed by way of example and not limitation.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 8, illustrative cloud computing environment 50 is depicted. As shown, cloud computing environment 50 includes one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 40 and cloud computing environment 50 can communicate with any type of computerized device over any type of network and/or network addressable connection (e.g., using a web browser).

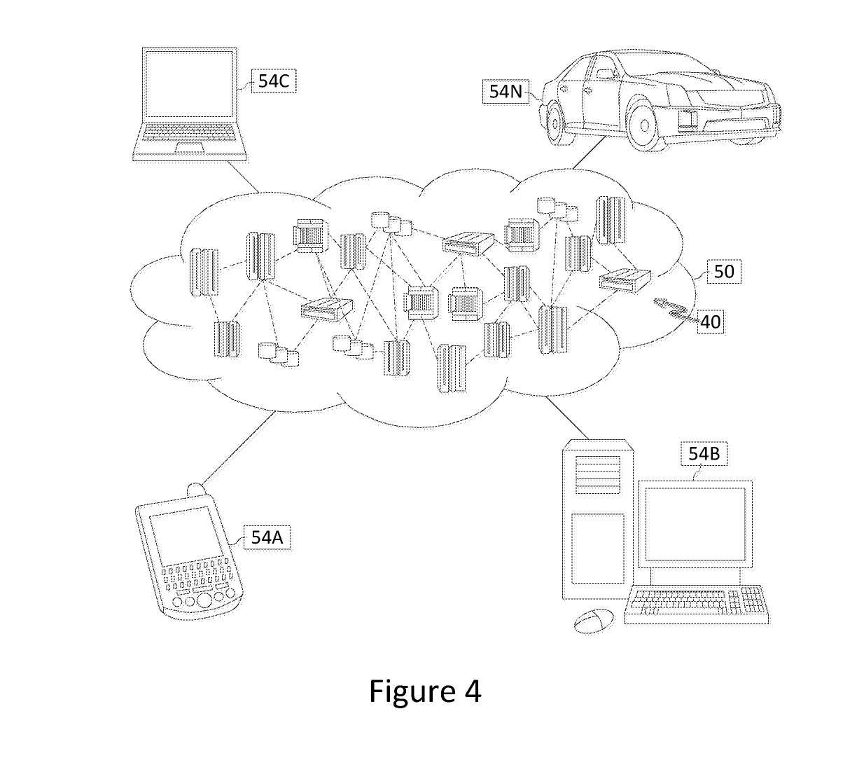

Referring now to FIG. 9, a set of functional abstraction layers provided by cloud computing environment 50 (FIG. 4) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and image processing 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method for determining optimal conditions to photograph a point of interest, the method comprising:
receiving, by a computer, a point of interest; and
determining, by the computer, optimal conditions to photograph the point of interest based on a model.

2. The method of claim 1, wherein the model correlates a quality of one or more images depicting the point of interest with one or more conditions related to capturing each of the one or more images.

3. The method of claim 2, wherein the quality of the one or more images is determined by generating one or more image histograms corresponding to the one or more images.

4. The method of claim 2, wherein identifying the one or more images depicting the point of interest further comprises:
identifying, by the computer, one or more verified images depicting the point of interest; and
applying, by the computer, image processing technology to identify one or more candidate images having features that match those of the one or more verified images.

5. The method of claim 2, wherein identifying the one or more images depicting the point of interest further comprises:
identifying, by the computer, one or more geotags associated with the point of interest; and
identifying, by the computer, one or more candidate images having a same geotag as the one or more geotags associated with the point of interest.

6. The method of claim 5, wherein the one or more geotags associated with the point of interest include at least one geotag from which the point of interest is visible but not present.

7. The method of claim 2, wherein the one or more conditions related to capturing each of the one or more images are identified by at least one of:
analysing, by the computer, metadata and exchangeable image files associated with the one or more images; and
applying, by the computer, image processing technology to the one or more images.

8. A computer program product for determining optimal conditions to photograph a point of interest, the computer program product comprising:
one or more computer-readable storage media and program instructions stored on the one or more computer-readable storage media, the program instructions comprising:
program instructions to receive a point of interest; and
program instructions to determine optimal conditions to photograph the point of interest based on a model.

9. The computer program product of claim 8, wherein the model correlates a quality of one or more images depicting the point of interest with one or more conditions related to capturing each of the one or more images.

10. The computer program product of claim 9, wherein the quality of the one or more images is determined by generating one or more image histograms corresponding to the one or more images.

11. The computer program product of claim 9, wherein the program instructions to identify the one or more images depicting the point of interest further comprises:
program instructions to identify one or more verified images depicting the point of interest; and
program instructions to apply image processing technology to identify one or more candidate images having features that match those of the one or more verified images.

12. The computer program product of claim 9, wherein the program instructions to identify the one or more images depicting the point of interest further comprises:
program instructions to identify one or more geotags associated with the point of interest; and
program instructions to identify one or more candidate images having a same geotag as the one or more geotags associated with the point of interest.

13. The computer program product of claim 12, wherein the one or more geotags associated with the point of interest include at least one geotag from which the point of interest is visible but not present.

14. The computer program product of claim 9, wherein the one or more conditions related to capturing each of the one or more images are identified by at least one of:
program instructions to analyse metadata and exchangeable image files associated with the one or more images; and
program instructions to apply image processing technology to the one or more images.

15. A computer system for determining optimal conditions to photograph a point of interest, the computer system comprising:
one or more computer processors, one or more computer-readable storage media, and program instructions stored on one or more of the computer-readable storage media for execution by at least one of the one or more processors, the program instructions comprising:
program instructions to receive a point of interest; and
program instructions to determine optimal conditions to photograph the point of interest based on a model.

16. The computer system of claim 15, wherein the model correlates a quality of one or more images depicting the point of interest with one or more conditions related to capturing each of the one or more images.

17. The computer system of claim 16, wherein the quality of the one or more images is determined by generating one or more image histograms corresponding to the one or more images.

18. The computer system of claim 16, wherein the program instructions to identify the one or more images depicting the point of interest further comprises:
program instructions to identify one or more verified images depicting the point of interest; and
program instructions to apply image processing technology to identify one or more candidate images having features that match those of the one or more verified images.

19. The computer system of claim 16, wherein the program instructions to identify the one or more images depicting the point of interest further comprises:
program instructions to identify one or more geotags associated with the point of interest; and
program instructions to identify one or more candidate images having a same geotag as the one or more geotags associated with the point of interest.

20. The computer system of claim 16, wherein the one or more conditions related to capturing each of the one or more images are identified by at least one of:
program instructions to analyse metadata and exchangeable image files associated with the one or more images; and
program instructions to apply image processing technology to the one or more images.
